(19) United States
(12) Patent Application Publication
(10) Pub. No.: US 2026/0368709 A1
(43) Pub. Date: Nov. 19, 2026

(54) SYSTEMS AND METHODS OF DEVICE MANAGEMENT

(71) Applicant: 1000431897 ONTARIO LIMITED, North York (CA)

(72) Inventors: John GEDEON, Toronto (CA); Chris DRITSAS, Etobicoke (CA); Peter ZOUMBOULAKIS, Markham (CA); Anil JAISINGHANI, Oakville (CA)

(21) Appl. No.: 19/155,140

(22) PCT Filed: Feb. 9, 2023
(86) PCT No.: PCT/CA2024/050170

§ 371 Date: Aug. 8, 2025

Related U.S. Application Data
(60) Provisional application No. 63/444,509, filed on Feb. 9, 2023.

(51) Int. Cl. G06Q 20/18

(52) U.S. Cl. CPC G06Q 20/18

(57) ABSTRACT

There is disclosed herein systems and methods for access to, activation of, and/or use of unattended devices. In some embodiments, access is provided via scanning of QR codes and/or the use of near-field communication without need for a user to utilize pre-loaded software or payment.

The present disclosure relates generally to systems and methods to access and/or make use of unattended or less than fully attended devices and, more particularly to improved systems and methods for device management.

### BACKGROUND

Self-service devices and access to the same are desirable for numerous reasons. Included among these are the desire of consumers for convenience and freedom (e.g., access to devices common business hours; access in locations where service volumes do not support human staffing, etc.). The range of unattended devices is wide and growing quickly, from examples such as vending machines, car washes, and so on).

Known systems and methods for unattended device access and/or operation include a separate device that integrates with a self-service system/machine (for example and without limitation: kiosks, vending machine, appliance, car washes, air compressors, etc.). Additional known systems and methods specific to particular market verticals and/or require proprietary applications to be downloaded to user devices (and, in some cases, accounts to be registered) and requirements to pre-load funds.

Known systems and methods are also costly, limiting their applicability, both generally and particularly in lower-volume need scenarios where such costs cannot be offset by operational scale. Known systems and methods are also typically maintained in a closed manner including, for example and without limitation, requirements of particular device manufacturers and/or service providers in respect of hardware and/or software. This also serves to limit access and applicability by, for example, narrowing use to limited functions of the given entity. Secure keys are also typically required in known product attempts, along with dedicated software, which heightens installation, maintenance and use costs, without discernible benefits in function.

The requirement to physically mount any secondary and external device adds complexity, costs, and brings with it significant risks of damage (poor installation, vandalism, unnecessary wear given the external device's integration with the unattended device.

Existing devices by their nature make it very difficult to add new payment types/modes, or features pertaining to access, upgrades, maintenance, without extensive upgrading or updating of existing hardware on site (which must be done whilst still meeting, for example and without limitation, payment card brand requirements.

Further, the requirement of physical presence at the external device to swap or service it in situ is costly and cumbersome from a logistical perspective.

Some known products require use of proprietary hardware and/or software (e.g., on a mobile device) and the pre-loading of funds. Both are cumbersome and require forethought rather than on-the-spot and substantially real-time decision making and access. This is in part an issue of convenience but such issues are highly relevant to consumer uptake and use of devices in a convenience-driven world. This issue is heightened where the unattended devices to be accessed are in public environments wherein they may be encountered by a wider variety of users.

Some known systems deposit end user funds into intermediary bank accounts (be they of the device/service provider or otherwise) prior to release of such funds to the client employing the system. Such systems exhibit delays in merchant receipt of funds and, introduce malfunction and security risks associated with additional transfers.

As such, there is a need for systems, methods and end products related thereto that eliminate or mitigate one or more of the issues described above.

### BRIEF SUMMARY

There is disclosed here device management systems including a single-layer root node, a plurality of multi-layer intermediate nodes, and single-layer leaf nodes.

The leaf nodes have location/health and data of device information on distribution areas and contents data.

A subset of the intermediate nodes is equipped with pointers to ones of the leaf nodes and location information having a minimum bounding rectangle that bounds the distribution areas corresponding to the leaf nodes underneath with a minimum area;

Tree-structured area management data is stored in a contents distribution server (the cloud broker) and is used by the contents distribution server to perform automated and payment processing to identify/and enable ones of the leaf nodes corresponding to distribution areas that geographically bound current location information input as a QR code in accordance with the pointers owned by the root node or the intermediate nodes.

There is also disclosed herein device management methods including: a contents distribution server stores tree-structured area management data; the server acquires current location information as a heartbeat mechanism; the server identifies intermediate nodes corresponding to a minimum bounding rectangle that geographically contains the current location information by comparing location information of the minimum bounding rectangle owned by the intermediate nodes underneath a root node with the said current location information.

The comparing is repeated in respect of location information of the minimum bounding rectangle owned by the subordinate intermediate nodes of the intermediate nodes or location information of the distribution areas owned by the leaf nodes with the current location information until ones of the leaf nodes corresponding to ones of the distribution areas that geographically contain the current location information are identified.

The distribution of contents data owned by the identified leaf nodes to users.

In some disclosed embodiments, the contents data comprises data on items, orders and payments, the payments comprising card-present and card-not-present payments, that were processed out of band, from a point-of-sale, e-commerce site, in lieu of coins and bills, and then passed on to the leaf node to acuate the managed device to render worth the amount of the payments via one or more interfaces.

In some disclosed embodiments, methods further comprising gathering collected data comprising metrics and meta data of the leaf nodes, the collected data including, like weight, temp, stocks, power, feedback, videos, pictures, user biometric, and reports the collected data to the contents distribution server for analysis, machine learning, and predictive analysis.

### BRIEF DESCRIPTION OF THE DRAWINGS

There are appended herewith various drawings setting out non-limiting, exemplary embodiments of systems and methods disclosed herein and portions thereof.

FIG. 1. is a schematic overview of systems disclosed herein;

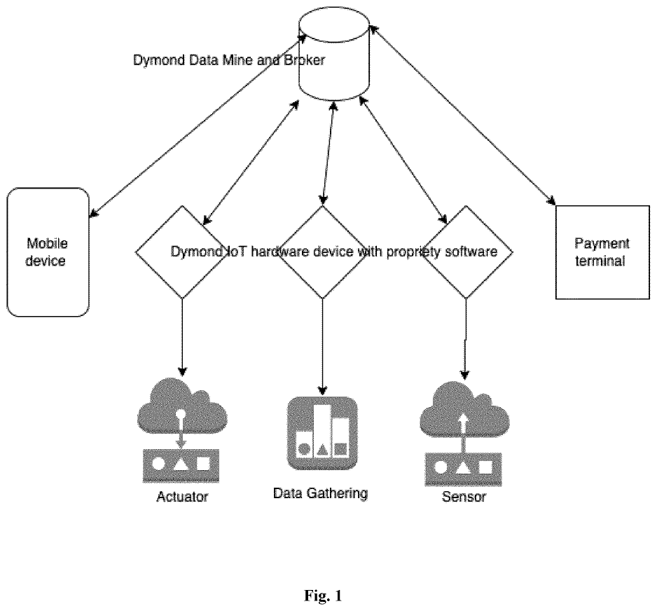

FIG. 2 a further schematic overview of systems disclosed herein;

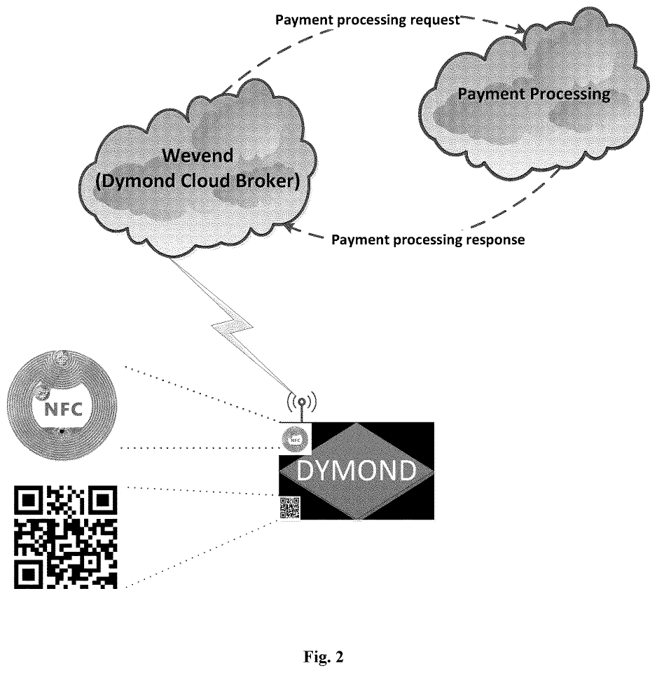

FIG. 3 is a flowchart illustrating methods disclosed herein;

FIG. 4 is a schematic representation of integration of methods and systems disclosed herein with 3^{rd} party applications; and,

FIG. 5 is a further schematic representation of the function of methods and systems disclosed herein with non-limiting examples of 3^{rd} party applications.

### DESCRIPTION

There is disclosed herein systems 100 and methods 300 for device management. In some embodiments, the systems 100 comprise a cloud broker 102 functioning as a hub of a plurality of control devices 104, and which broker 102 controls, archives and monitors all the control devices 104 and transactions related thereto. Connections to the cloud broker 102 comprise secure links hosted in the cloud.

At least one IoT device 106 is provided comprising a hardware board 106 for connecting via multiple topolocommunication protocols to the cloud broker 102. The hardware board 106 includes, for example and without limitation, the following hardware interfaces that are or can:
1. emulate multiple coin accepting device(s) using a coin pulse that is programmable
2. connect and drive multiple solenoids and relays
3. sensors inputs for feedback from managed devices (Mic, Speaker, Weight, Temperature, Environmental Variables, LEDs and other transactional data from machine controller such as DEX, etc., as well as digital images/videos and biometric information) to enable machine learning algorithms for improving predictive behaviour
4. a serial USB interface to securely communicate with serial devices (for example, CC talk and the like)
5. a Multi Drop Bus (MDB) interface for connection to devices utilizing the international standard for any unattended vending or self-serve machines
6. Openchargealliance.org standard for interfacing to electric charging including but not limited to Electric Vehicle charging and the like.
7. Cellular SIM connectivity with the option to enable a Wi-Fi hotspot to interconnect all wi-fi enabled devices within the vicinity of the IoT in order to enable the processing of transactions and/or driving machine behaviour
8. Specific vertical user experience that allows for:
a. Invoicing and adding multiple menu items to a shopping cart
b. Ability to add local, state or federal taxes
c. Ability to include a tipping feature
d. Ability to issue a soft receipt to the End User via text or email by either entering client information or scanning a QR Code or providing other communications interface or enabling information
e. Integration into proprietary or open customer loyalty programs such as campus cards and the like.
f. Ability to offer time based solutions such as ‘Count Up’ or ‘Count Down’ for machine operation, control, and activation/de-activation of services such as car wash, tire inflator, vacuum, kiosks and other. For example, a timer counts up or counts down until the time of services expires
g. Ability to support both pre-authorized payments and single transaction payments to initiate machine control.

An appliance leaf 108 is provided for triggering the activity or change in state of a managed device 110, which activity or change in state can be in respect of any electrical, mechanical, audio, video, input/output device property or state.

The IoT device 106 may be installed within the managed device 110. A QR Code or NFC tag will be used by an end user (EU). When the EU scans the QR Code or taps the NFC label using their device (e.g., phone), it will bring the EU to a pre-configured landing page with special instructions and fee(s) to be charged. Included payment solutions will execute the payment option on the EU's mobile device.

Upon successful payment, a message is sent to the IoT device 106 which will then send a relay message to activate the managed device 110 to trigger the activity or change of state (e.g., the machine, appliance, mechanism, solenoid, service, etc., tied thereto).

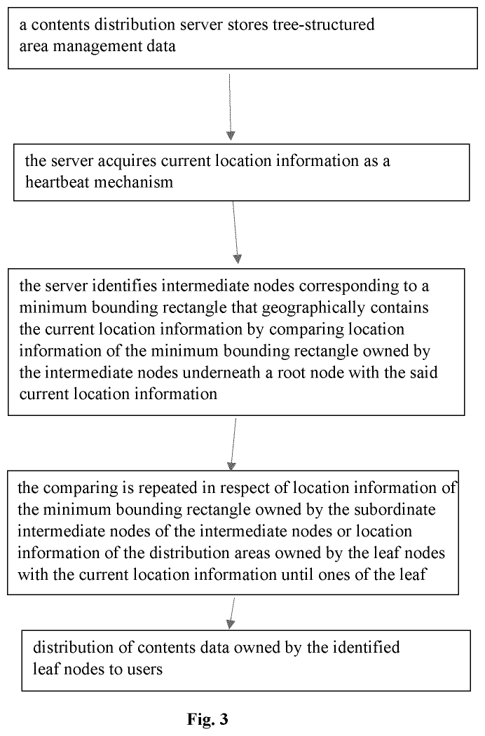

As shown in FIG. 3, methods 300 disclosed herein for using the system 100 may comprise steps such as those disclosed herein and described below. An End User scans a QR code or taps an NFC tag at a managed device. The End User does so, for example, with its mobile device. The mobile device is brought to a landing page (for example and without limitation, pop-up in application and/or browser options). The End User is presented with options and pricing related to the managed device. The options and pricing will vary depending on the nature of the managed device, with examples including in the context of a car wash, menu features may include additional time, shampoo; in a laundry context, features may include more time; vending contexts may include menu features such as snack menus, etc. ; parking lot menu features may include time management; electric vehicle (EV) charging menus may include time management, amperage, etc. Some embodiments may exhibit concerns requiring design solutions for particular use scenarios; examples include, without limitation, in the context of connecting to a solenoid to unlatch a lock, such as opening a parking garage door, unlocking a cooler, activating a video game or arcade, activating the controls to dispense liquids such as windshield wash, activating machines amongst other things.

The End User then makes any available selections and proceeds to payment authorization via a card not present method or manual entry of other payment details. Some single choice embodiments may not require user selections beyond process initiation (e.g., activation of the opening of a bathroom door; activation of a vending machine dispensing a single product type). In those and other embodiments, the processes and systems disclosed herein will include control of the device once the process is initiated.

In some embodiments disclosed herein, unattended payment terminals may be provided and cooperate with the disclosed systems and methods. Examples include integration of such payment methods wherein the user is pushed to the payment terminal after the selection. Traditional unattended payment device may also be provided to accept payment in a card present manner utilizing contactless tap or chip insert (EMV).

Data and meta data gathering may include, for example and without limitation, via secure chat talk to the IoT device asynchronously via the broker. In some embodiments, sensory data such as, for example and without limitation, telemetry data, videos and images, sound, weight, temperature, environmental variables may be gathered.

QR Code and/or NFC technology combine with the IoT device and a cloud-based ecosystem for use as part of the disclosed systems and methods to provides low-cost solutions in self-service to activate any managed device, for example, to vend or dispense product(s). This facilitates asynchronous control of large volumes of IoT devices through their life cycles.

Systems 100 and methods 300 disclosed herein also enables users to take advantage of mobile payments for cashless interfaces at managed devices in the form of unattended solutions (i.e., accepting payment to enable activation of the managed device) .

System agility and ease of use is enhanced by the lack of need for prior downloading of proprietary application software and/or pre-loading of funds. In some embodiments disclosed herein, payments solutions such as, for example and without limitation, ApplePay™, GooglePay™, AndroidPay™, smart device wallet, and/or other digital means of effecting payment

In some embodiments, systems and methods disclosed herein solution can be used to control device with the combination of a smartphone app the user can direct devices in manners such as between states; such as, “open/close”, “on/off”, “activate/deactivate”, “allow access or disable” etc. One such embodiment comprises a portable toilet located, for example, at a public or otherwise openly accessible facility where there is a desire to limit access. The user may, for example, scans a QR or tap an NFC of the portable toilet, and the system opens the solenoid/lock allowing the user to access the portable toilet”. It removes the need for expensive and highly regulated unattended payment devices.

Embodiments disclosed herein would not be subject to current processor and card brands certification requirements as operation thereof is beyond the scope thereof (e.g., embodiments consisting of no card present payment device). Systems disclosed herein also exhibit significantly lower upfront cost for operator/merchants as compared to earlier unattended payment device.

In some embodiments, systems and methods may be provided whereby, for example, the dongle (alternatively and equivalently referred to herein as a dymond and/or leaf dymond) can not only initiate payment processing but can also initiate actions not requiring payment. Examples include, without limitation, turning on and off of devices, or varying operational settings thereof. This may include, for example and without limitation, on/off settings of devices, including at scheduled times and/or in response to user input. This may also include provision of time-based access to devices (e.g., scanning of a QR code to access to public or semi-public toilet during its hours of service. Such access may, in some embodiments, be limited to users of a client application (e.g., a STARBUCKS™M allowing access to washrooms or other facilities or infrastructure based on use of the related application and/or a transaction having occurred in a geo-fenced area.

One skilled in the art will appreciate that, while various means of initiating product, service or devices are specifically discussed herein, additional initiating steps would nonetheless cooperate with embodiments disclosed herein. Such initiating steps may also include, for example and without limitation, detection of motion, physical contact (e.g., bumping or kicking a vending machine to prompt vending).

There are also herein disclosed embodiments comprising systems and methods of interfacing with 3^{rd} party applications to control unattended and attended devices.

In some embodiments, these comprise extending the use of a, for example and without limitation, ride sharing, delivery and/or other similar applications and/or Alternate Payment methods (APM) such as, for example and without limitation, PAYPAL™, VENMO™ and other applications with similar functionality. This is to provide the marketing, payment and enabling of services to also encompass the control or activation of devices/machines, (e.g., unattended machines, services, including without limitation those available via such applications either directly or via goods/services providers accessible therethrough). These include but are not limited to vending, car wash, laundromats, electric vehicle (EV) charging using an automatic integrated or a semi-integrated approach (e.g., the dongle, as disclosed herein) for the enablement of the services.

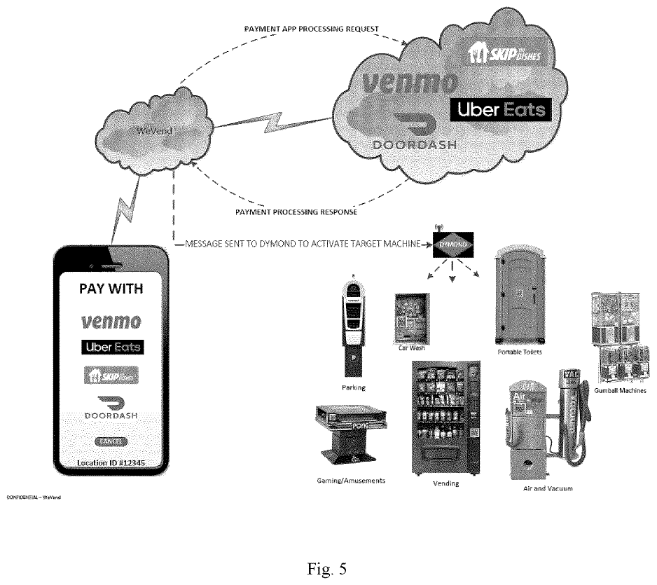

In a non-limiting examples of a consumer wishing to purchase a beverage at a vending machine located at their office, or a consumer purchases car wash (as shown schematically in FIG. 5).

Step 1: INVOKE the 3^{rd} party application (e.g., ride sharing/delivery/other parent application)

Step 2: CHOOSE the machine/scan QR code or use location services to identify machine

Step 3: MENU: Once the service or machine is chosen, displayed to user is a menu of services or products and/or prompt for payment (e.g., where there is only one choice)

Step 4: PAY-After selection, payment (or non-payment i.e. granting access) is completed using the parent app's platform

Step 5: ENABLE/DISPENSE-The goods and services will be enabled/dispensed using our proprietary interface, triggered by the parent apps fulfillment API

Step 6: TRANSACTION COMPLETED—once “services are enabled” or “goods dispensed”, a response indicating success is sent to the parent application.

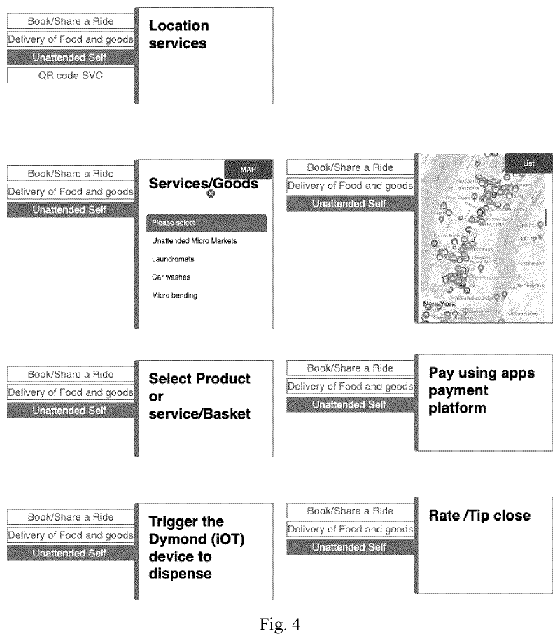

In a non-limiting example of applications making determinations based on location services (as shown schematically in FIG. 4):
Step 1: INVOKE the parent application (e.g., ride sharing/delivery/other)
Step 2: SELECT new added tab for, for example, unattended self-serve
Step 3: CHOOSE the geographic domain based on current location or postal/zip code
Step 4: LOCATE—Location services searches for unattended machines in the vicinity and displays them
Step 5: MENU—Once the service or machine is chosen, menu of services or products is displayed to user
Step 6: PAY—After selection, payment is made using the parent application's platform
Step 7: DISPENSE—The goods and services will be enabled by interface with systems and methods disclosed herein, and in some cases triggered by the parent application's fulfillment Application Program Interface (API)
Step 8: TRANSACTION COMPLETED—once “services are enabled” or “goods dispensed”, a success response is sent to the parent application

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

It will be understood that the principal features of this disclosure can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

Additionally, the section headings herein are provided as organizational cues. These headings shall not limit or characterize the invention(s) set out in any claims that may issue from this disclosure. Specifically, and by way of example, although the headings refer to a “Field” such claims should not be limited by the language under this heading to describe the so-called technical field. Further, a description of technology in the “Background” section is not to be construed as an admission that technology is prior art to any invention(s) in this disclosure. Neither is the “Brief Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, un-recited elements or method steps.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

The term “or combinations thereof” as used herein refers to all permutations and combinations of the listed items preceding the term. For example, “A, B, C, or combinations thereof is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosure. All such similar substitutes and modifications apparent to those skilled in the art are deemed to be within the spirit, scope and concept of the present disclosure including the appended claims.

1. A device management system, the system comprising,
a single-layer root node,
a plurality of multi-layer intermediate nodes, and
single-layer leaf nodes,
wherein, the leaf nodes have location/health and data of device information on distribution areas and contents data;
a subset of the intermediate nodes is equipped with pointers to ones of the leaf nodes and location information having a minimum bounding rectangle that bounds the distribution areas corresponding to the leaf nodes underneath with a minimum area;
wherein tree-structured area management data is stored in a contents distribution server (the cloud broker) and is used by the contents distribution server to perform automated and payment processing to identify/and enable ones of the leaf nodes corresponding to distribution areas that geographically bound current location information input as a QR code in accordance with the pointers owned by the root node or the intermediate nodes.

2. A device management method, the method comprising:
a contents distribution server stores tree-structured area management data;
the server acquires current location information as a heartbeat mechanism;
the server identifies intermediate nodes corresponding to a minimum bounding rectangle that geographically contains the current location information by comparing location information of the minimum bounding rectangle owned by the intermediate nodes underneath a root node with the said current location information;
the comparing is repeated in respect of location information of the minimum bounding rectangle owned by the subordinate intermediate nodes of the intermediate nodes or location information of the distribution areas owned by the leaf nodes with the current location information until ones of the leaf nodes corresponding to ones of the distribution areas that geographically contain the current location information are identified; and
distribution of contents data owned by the identified leaf nodes to users.

3. The method of claim 2, wherein, the contents data comprises data on items, orders and payments, the payments comprising card-present and card-not-present payments, that were processed out of band, from a point-of-sale, e-commerce site, in lieu of coins and bills, and then passed on to the leaf node to acuate the managed device to render worth the amount of the payments via one or more interfaces.

4. The method of claim 2, further comprising gathering collected data comprising metrics and meta data of the leaf nodes, the collected data including, like weight, temp, stocks, power, feedback, videos, pictures, user biometric, and reports the collected data to the contents distribution server for analysis, machine learning, and predictive analysis.
